(19) United States
(12) Patent Application Publication
(10) Pub. No.: US 2017/0178573 A1
(43) Pub. Date: Jun. 22, 2017

(54) DRIVING DEVICES AND DRIVING METHODS

(71) Applicant: Acer Incorporated, New Taipei City (TW)

(72) Inventor: Jui-Chieh HSIANG, New Taipei City (TW)

(21) Appl. No.: 15/352,777

(22) Filed: Nov. 16, 2016

(30) Foreign Application Priority Data
Dec. 17, 2015 (TW) 104142428

(51) Int. Cl. G09G 3/34; G02F 1/167; G09G 3/20

(52) U.S. Cl. CPC G09G 3/344; G09G 3/2085; G02F 1/167; G09G 2320/0257; G09G 2310/0262; G09G 2330/021; G09G 2310/04

(57) ABSTRACT

A driving device, adapted to an electronic paper, includes a storage unit, a processor, and a driver. The storage unit stores pixel values of all pixels corresponding to a current screen and pixel values of all pixels corresponding to a subsequent screen. The processor obtains an update region by comparing the pixel values of all pixels corresponding to the current screen and the pixel values of all pixels corresponding to the subsequent screen, and obtains edges of the update region. The driving unit updates the update region and adjacent pixels of the edges of the update region according to the pixel values of the subsequent screen.

### CROSS REFERENCE TO RELATED APPLICATIONS

This application claims priority of Taiwan Patent Application No. 104142428, filed on Dec. 17, 2015, the entirety of which is incorporated by reference herein.

### BACKGROUND OF THE INVENTION

Field of the Invention

The application relates in general to driving devices and driving methods for an electronic paper, and in particular to the driving devices and the driving methods for removing ghosting of the electronic paper by updating pixel values of adjacent pixels of the edges of the display region, changing the edges of the display region, and extending an update time or increasing the voltage of the electrodes.

Description of the Related Art

These days, due to the rapid development of technology, a variety of displays are continuously being developed for different situations. Because the characteristics of electronic paper include having low power consumption, being lightweight, having a long service life, and being flexible, it is widely used on different occasions. However, maintaining low power consumption or increasing the switching speed of the screen my cause ghosting, particularly in situations where there is insufficient voltage, or where the update time is shorter. Thus, how to solve the problem of ghosting without affecting user experience is a problem which needs to be solved immediately.

### BRIEF SUMMARY OF INVENTION

An embodiment of the invention provides a driving device, adapted to an electronic paper, including a storage unit, a processor, and a driver. The storage unit stores pixel values of all pixels corresponding to a current screen and pixel values of all pixels corresponding to a subsequent screen. The processor obtains an update region by comparing the pixel values of all pixels corresponding to the current screen and the pixel values of all pixels corresponding to the subsequent screen, and obtains edges of the update region. The driver updates the update region and adjacent pixels of the edges of the update region according to the pixel values of the subsequent screen.

Another embodiment of the invention provides a driving method, adapted to an electronic paper, including: obtaining, by a processor, pixel values of all pixels corresponding to a current screen from a storage unit; obtaining, by the processor, pixel values of all pixels corresponding to a subsequent screen from the storage unit; obtaining, by the processor, an update region by comparing the pixel values of all pixels corresponding to the current screen and the pixel values of all pixels corresponding to the subsequent screen; obtaining, by the processor, edges of the update region; and updating, by a driver, the update region and adjacent pixels of the edges of the update region according to the pixel values of the subsequent screen.

### BRIEF DESCRIPTION OF DRAWINGS

The invention can be more fully understood by reading the subsequent detailed description and examples with references made to the accompanying drawings, wherein:

FIG. 1 is a schematic diagram of an electronic paper in accordance with an embodiment of the invention;

FIG. 2 is a schematic diagram of a driving device of the electronic paper in accordance with an embodiment of the invention;

FIGS. 3A-3C are schematic diagrams of ghosting of the electronic paper in accordance with an embodiment of the invention;

FIG. 4 is a schematic diagram for synchronously updating adjacent pixels of the edges in accordance with an embodiment of the invention;

FIGS. 5A, 5B are schematic diagrams for synchronously updating adjacent pixels of the edges in accordance with another embodiment of the invention;

FIG. 6 is a flow chart of a driving method for the electronic paper in accordance with an embodiment of the invention.

### DETAILED DESCRIPTION OF INVENTION

Further areas in which the present devices and methods can be applied will become apparent from the following detailed description. It should be understood that the detailed description and specific examples, while indicating exemplary embodiments of the driving devices and the driving method of the electronic paper, are intended for the purposes of illustration only and are not intended to limit the scope of the invention.

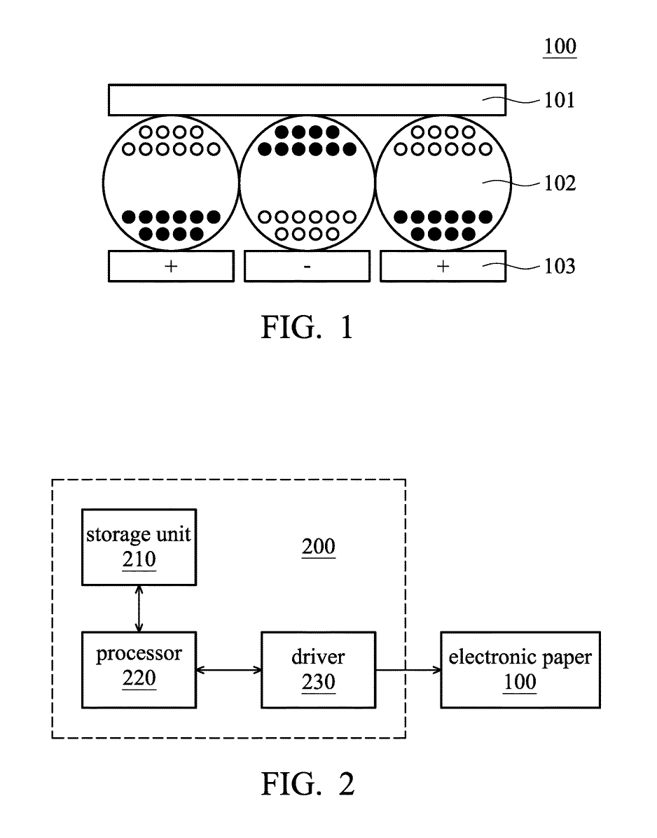

FIG. 1 is a schematic diagram of an electronic paper in accordance with an embodiment of the invention. The electronic paper 100 includes a transparent substrate 101, electronic ink layer 102, and a transparent substrate 103. The transparent substrate 101 faces to the user, and has a common electrode. The electronic ink layer 102 is composed of a plurality of microcapsules. Each microcapsule includes white particles with a positive charge and black particles with a negative charge. The transparent substrate 103 includes electrodes, the driving device alternately provides a positive voltage or a negative voltage to the electrodes for controlling the moves of the white particles and the black particles within the electronic ink layer 102. For example, when the transparent substrate 103 is provided with a positive voltage, the black particles with negative charge move down, and the electronic paper 100 displays a white screen. In contrast, when the transparent substrate 103 is provided with a negative voltage, the white particles with a positive charge move down, and the electronic paper 100 displays a black screen.

FIG. 2 is a schematic diagram of a driving device of the electronic paper in accordance with an embodiment of the invention. The driving device 200 includes a storage unit 210, a processor 220, and a driver 230. The storage unit 210 stores pixel values of all pixels corresponding to a current screen and pixel values of all pixels corresponding to a subsequent screen. The storage unit 210 can be the conventional memory or the disk drive. The processor 220 obtains an update region by comparing the pixel values of all pixels corresponding to the current screen and the pixel values of all pixels corresponding to the subsequent screen. For reducing the power consumption of the electronic paper, in the conventional technology, the driver of the electronic paper will not provide the voltage to the electrodes corresponding to the region that the pixel values do not change when the display screen switches. Thus the update region refers to the region where the pixel values change. The driver 230 provides the voltage to the electrodes of the update region and the electrodes of the adjacent pixels of the edges of the update region according to the pixel values of the subsequent screen for updating the display screen.

Please refer to Table 1. Table 1 shows the conventional update mode of electronic paper.

TABLE 1

| update mode | mode | times (ms) |
|---|---|---|
| global refresh | INIT | 2000 |
| | GC | 600~980 |
| Partial refresh | GU | 320 |

In cases where the driver 230 provides a fixed voltage, the refresh mode can be divided into two categories: global refresh and partial refresh. The global refresh further includes INIT (Initialize) mode and GC (Grayscale clear) mode. The INIT mode completely clears the screen, but its disadvantage is that it takes a long time. In the GC mode, all pixels are refreshed or cleared. Even though it is less time consuming than the INIT mode, it flashes seriously. However, both INIT mode and GC mode have less ghosting. Otherwise, the partial refresh includes GU (Grayscale update) mode. The GU mode updates the pixels that need to be updated to a specific gray value. The advantages are that it has fewer flickers and takes less time, but it generates more ghosting.

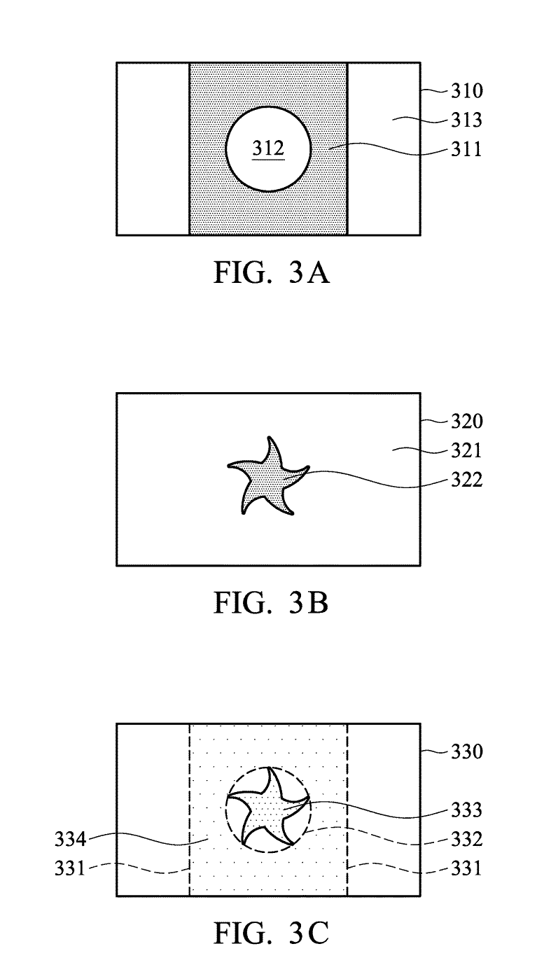

Please refer to FIGS. 3A-3C. FIGS. 3A-3C are schematic diagrams of ghosting of electronic paper in accordance with an embodiment of the invention. FIG. 3A represents the current screen of the electronic paper. As shown in FIG. 3A, the current screen 310 can be divided into a black region 311, a white region 312, and a white region 313. FIG. 3B represents the subsequent screen of the electronic paper. As shown in FIG. 3B, the subsequent screen 320 can be divided into a white region 321 and a black region 322. However, when the processor 220 uses the partial refresh to update the subsequent screen, the ghosting shown in FIG. 3C might appear.

Regarding sideline 331 and sideline 332, because the driver 230 only updates the pixels for which the pixel values change, for the subsequent screen 320, the processor 220 only updates the black region 311 to white, and updates part of the white region 312 to black. Because the white region 313 still maintains white in the subsequent screen, the driver 230 will not update the pixels within the region. In cases where the electrodes corresponding to the black region 311 are provided with the voltage and the electrodes corresponding to the white region 313 are not provided with the voltage, after updating the screen several times, the microcapsules between the black region 311 and the white region 313 will have transverse electric fields. That will cause a maldistribution of the black particles and the white particles within the microcapsules, and generate sideline 331 and sideline 332.

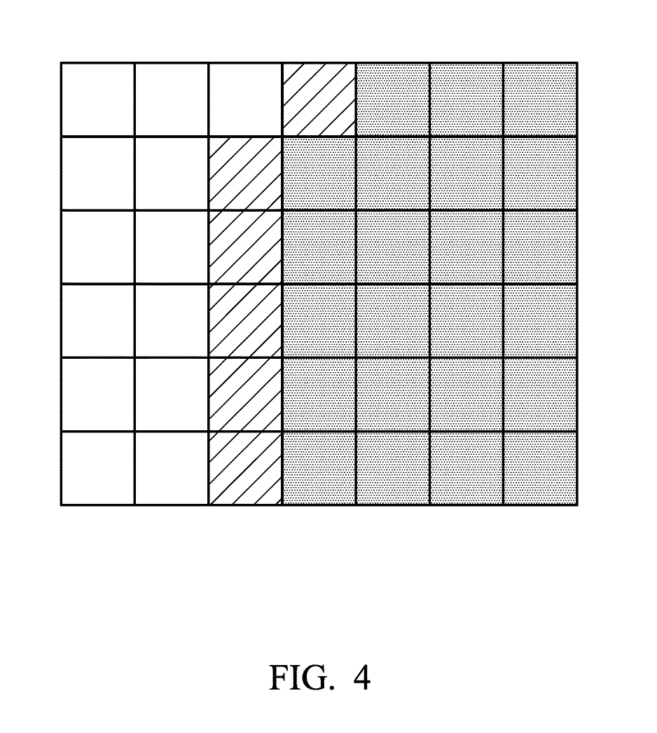

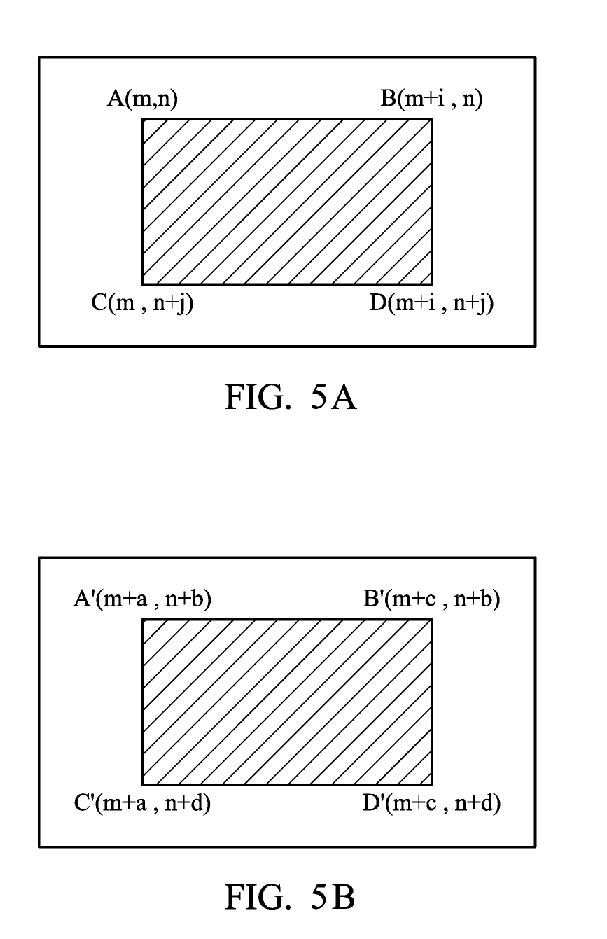

For solving the problems described above, according to an embodiment of the present invention, the processor 220 processes the adjacent pixels of the edges of the update region for removing the transverse electric field. For example, FIG. 4 is a schematic diagram for synchronously updating adjacent pixels of the edges in accordance with an embodiment of the invention. As shown in FIG. 4, the black region represents the region that will be updated in the subsequent screen, and the slash region represents the pixels that might have a transverse electric field. In the embodiment, even though the pixel values of the pixels within the slash region will not change, the driver 230 still provides an appropriate voltage to the pixels within the slash region. That ensures that the black particles and the white particles within the microcapsules can correctly maintain the original distribution for avoiding the effect of the transverse electric field.

FIGS. 5A, 5B are schematic diagrams for synchronously updating adjacent pixels of the edges in accordance with another embodiment of the invention. According to another embodiment of the present invention, when the processor 220 only updates a specific region each time, such as the slash region composed by point A, point B, point C, and point D shown in FIG. 5A, because the driver 230 only provides the voltage to the electrodes within the slash region, after several updates, the transverse electric field will be gradually generated at the edges of the slash region. For solving the problem described above, after the driver 230 updates the screen a predetermined number of times, e.g. 2-3 times, without affecting the display content of the slash region, the processor 220 will slightly change the coordinates of the edges of the specific region, for example changing the coordinates of point A, point B, point C, and point D to the coordinates of point A′, point B′, point C′, point D′, and that might effectively avoid the transverse electric field within the microcapsules of the adjacent pixels of the fixed edge.

For reducing power consumption and providing a better user experience, when the driver 230 updates region 333 and region 334, the voltage provided to the electrodes might not be enough or the update time might not long enough. That means that the pixel values within the region will not be updated to the correct pixel values, which means the distribution of the black particles and the white particles within the microcapsule is incorrect, which might cause a problem with the dark region, e.g. region 333, not being dark enough, and the light region, e.g. region 334, not being light enough. However, according to an embodiment of the present invention, the processor 220 extends the update time or increases the update voltage to solve these problems, depending on the user's operational requirements. For example, when the electronic paper is operating in a clock mode, because the user will not look at the display screen for long periods, the processor 220 enables the driver 230 to extend the update time, thereby avoiding ghosting. Otherwise, when the user frequently operates the electronic paper, the processor 220 enables the driver 230 to increase the update voltage, solving the aforementioned problems.

According to an embodiment of the present invention, ways of extending the update time include using different modes to intensify the update of the pixel values. For example, under the GC mode, the way that the pixel value is updated from the first pixel value to the second pixel value is: the first pixel value→all white (or all black)→all black (or all white)→the second pixel value. However, the pixels can be updated by the INT mode when the pixel value is updated from the first pixel value to all white (or all black). Even though the update time is a little bit longer, it effectively reduces the ghosting generated by updating from the first pixel value to all white (or all black), and the image quality becomes better. Otherwise, the pixels can also be updated by the INT mode when the pixel values are updated from all white (or all black) to all black (or all white). That will more completely remove the ghosting generated by the first pixel value, and make the final image quality closer to the image quality that totally uses the INT mode.

According to another embodiment of the present invention, in cases where the update time is not extended, the processor 220 is able to adjust the distribution of the black particles and the white particles within the microcapsules by increasing the update voltage. For example, when the voltage is V, by way of extending the update time, the driver 230 has to spend (T+T′) for adjusting the pixel values to the correct values. However, without extending the update time, the processor 220 enables the driver 230 to increase the voltage to (V+V′) for accelerating the moving speed of the black particles and the white particles within the microcapsules in order to achieve the effect of adjusting the pixel values. It should be noted that, as described above, the display effect of the electronic ink will be different due to the production process, thus the processor 220 determines the increased voltage by looking up the lookup table for calculating the relationship between voltage and time.

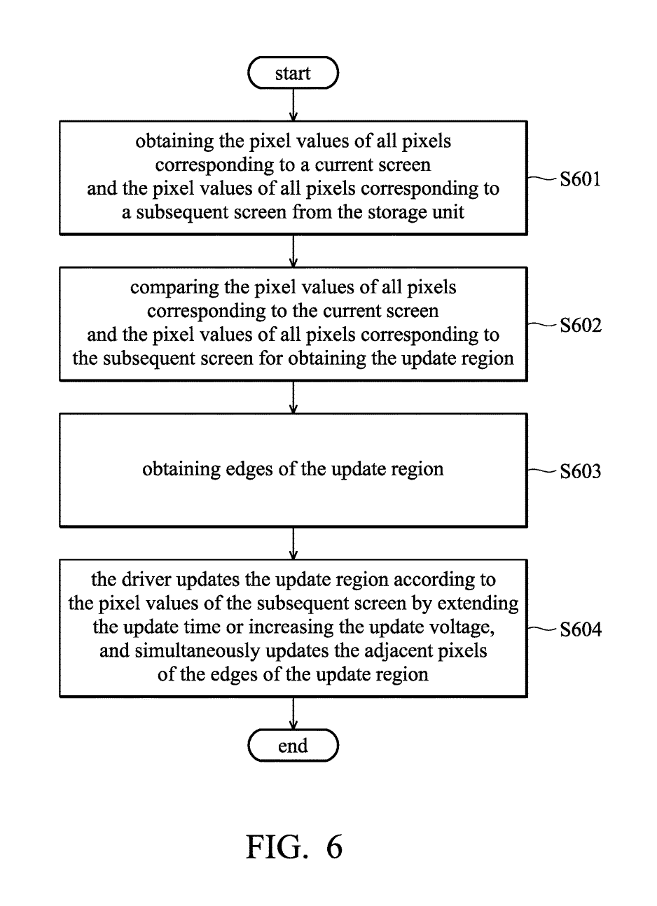

FIG. 6 is a flow chart of a driving method for the electronic paper in accordance with an embodiment of the invention. In step S601, the processor 220 obtains the pixel values of all pixels corresponding to a current screen, and obtains the pixel values of all pixels corresponding to a subsequent screen from the storage unit 210. In step S602, the processor 220 compares the pixel values of all pixels corresponding to the current screen and the pixel values of all pixels corresponding to the subsequent screen, and sets the region in which the pixel values are changed as an update region. In step S603, the processor 220 obtains edges of the update region. In step S604, the driver 230 updates the update region according to the pixel values of the subsequent screen by extending the update time or increasing the update voltage, and simultaneously updates the adjacent pixels of the edges of the update region.

As described above, the present invention provides a driving device and driving method for electronic paper. The ghosting generated at the edges of the update region can be removed by periodically changing the edges of the update region or updating the adjacent pixels of the update region which are not being updated using the same pixel values by the driver. Problems with the dark region not being dark enough and the light region not being light enough can be avoided by selectively extending the update time of the update region, or by providing a higher voltage in different situations for providing a better display quality and experience for the user.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A driving device, adapted to an electronic paper, comprising:
a storage unit, storing pixel values of all pixels corresponding to a current screen and pixel values of all pixels corresponding to a subsequent screen;
a processor, obtaining an update region by comparing the pixel values of all pixels corresponding to the current screen and the pixel values of all pixels corresponding to the subsequent screen, and obtaining edges of the update region; and
a driver, updating the update region and adjacent pixels of the edges of the update region according to the pixel values of the subsequent screen.

2. The driving device as claimed in claim 1, wherein when the adjacent pixels of the edges are not in the update region, the driver updates the adjacent pixels according to the pixel values of the current screen.

3. The driving device as claimed in claim 1, wherein when the edges of two consecutive update regions are the same, the processor changes locations of the edges.

4. The driving device as claimed in claim 1, wherein the storage unit further comprises a lookup table, and the processor enables the driver extend an update time for the update region according to the lookup table.

5. The driving device as claimed in claim 1, wherein the storage unit further comprises a lookup table, and the processor enables the driver to increase an update voltage for the update region according to the lookup table.

6. A driving method, adapted to an electronic paper, comprising:
obtaining, by a processor, pixel values of all pixels corresponding to a current screen from a storage unit;
obtaining, by the processor, pixel values of all pixels corresponding to a subsequent screen from the storage unit;
obtaining, by the processor, an update region by comparing the pixel values of all pixels corresponding to the current screen and the pixel values of all pixels corresponding to the subsequent screen;
obtaining, by the processor, edges of the update region; and
updating, by a driver, the update region and adjacent pixels of the edges of the update region according to the pixel values of the subsequent screen.

7. The driving method as claimed in claim 6, the step for updating the update region and the adjacent pixels of the edges of the update region according to the pixel values of the subsequent screen further comprising:
updating, by the driver, the adjacent pixels according to the pixel values of the current screen when the adjacent pixels of the edges are not in the update region.

8. The driving method as claimed in claim 6, the step for updating the update region and the adjacent pixels of the edges of the update region according to the pixel values of the subsequent screen further comprising:
changing, by the processor, locations of the edges when the edges of two consecutive update regions are the same.

9. The driving method as claimed in claim 6, the step for updating the update region and the adjacent pixels of the edges of the update region according to the pixel values of the subsequent screen further comprising:
enabling, by the processor, the driver extend an update time for the update region according to a lookup table.

10. The driving method as claimed in claim 6, the step for updating the update region and the adjacent pixels of the edges of the update region according to the pixel values of the subsequent screen further comprising:
enabling, by the processor, the driver to increase an update voltage for the update region according to a lookup table.
